(19) United States
(12) Patent Application Publication
(10) Pub. No.: US 2008/0099675 A1
(43) Pub. Date: May 1, 2008

(54) Inspection apparatus and an inspection method

(75) Inventors: Takashi Hiroi, Yokohama (JP); Hiroshi Miyai, Hitachi (JP); Hirokazu Ito, Hitachinaka (JP); Michio Nakano, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 11/976,965

(22) Filed: Oct. 30, 2007

(30) Foreign Application Priority Data
Oct. 31, 2006 (JP) 2006-296120

(51) Int. Cl. G21K 5/04

(52) U.S. Cl. 250/307; 250/310

(57) ABSTRACT

An inspection apparatus includes an irradiation optical system for irradiating an inspection target with an electron beam, a scanning unit for scanning an irradiation position in the X direction and the Y direction, an electrification control electrode for controlling secondary electrons or reflected electrons generated on the inspection target by the irradiation with the electron beam, a sensor for detecting the secondary electrons or the reflected electrons, an A/D converter for sequentially converting the signals into digital image signals from an irradiation start point-in-time of the electron beam, an addition circuit for creating a detection image by adding the digital image signals from a first set point-in-time to a second set point-in-time on each pixel basis, and an image processing circuit for judging a defect by comparing the detection image with a reference image of a circuit pattern formed on the inspection target.

### BACKGROUND OF THE INVENTION

1. Field of the Invention

The present invention relates to a semiconductor wafer inspection apparatus and its inspection method for inspecting defects of an inspection target having a circuit pattern, using an electron beam.

2. Description of the Related Art

An embodiment of conventional electron-beam type pattern inspection apparatuses is disclosed in JP-A-5-258703 (U.S. Pat. No. 5,502,306). This electron-beam type pattern inspection apparatus irradiates a semiconductor wafer of the inspection target with an electron beam, then detecting secondary electrons generated on the surface of the semiconductor wafer. Also, this electron-beam type pattern inspection apparatus scans the electron beam, thereby making it possible to acquire a secondary-electron image of the circuit pattern on the semiconductor wafer. Moreover, the electron-beam type pattern inspection apparatus compares the detected inspection image with a reference image of the same circuit pattern. This comparison allows the inspection apparatus to judge that a location at which a significant difference exists between the two images is a defect.

### SUMMARY OF THE INVENTION

Materials and configurations of which a circuit pattern is formed have been diversified and complicated. In correspondence with this trend, types of defects have also increased in number. Depending on the types of defects, conditions on suitable electron-optics systems come to differ. For example, non-conduction inspection at a hole processing step requires precharge function and high-sensitivity detection function for negative-potential potential contrast. Also, detection of a short-circuit defect requires high-sensitivity detection function for positively-charged potential contrast.

Also, in recent years, in accompaniment with microminiaturization of devices, detection function for microscopic defects has been getting increasingly requested. Detecting the microscopic defects requires the use of a high-resolution electron-optics system. In general, however, there is the following tendency: If current amount of the electron beam is made smaller, high resolution is implemented; whereas S/N ratio is lowered. When the S/N ratio is lowered, it becomes difficult to distinguish between the microscopic defects and noises. Accordingly, as countermeasures to be taken, the S/N ratio is enhanced by detecting the image over a plurality of times, and adding and averaging images thus detected.

In some cases, however, intensity of secondary electrons or reflected electrons changes in time. In this case, even if the circuit pattern is scanned over a plurality of times, the equivalent images are not necessarily detected. In the conventional inspection apparatuses, no consideration has been given to these points.

In view of this situation, an object of the present invention is to provide a semiconductor wafer inspection apparatus and its inspection method for allowing the semiconductor wafer inspection to be performed under a suitable condition even if the intensity of secondary electrons or reflected electrons changes in time.

In order to accomplish the above-described object, the semiconductor wafer inspection apparatus of the present invention includes an irradiation optical system for irradiating an inspection target with an electron beam, a scanning unit for scanning an irradiation position of the electron beam of the irradiation optical system in the X direction and the Y direction, an electrification control electrode for controlling secondary electrons or reflected electrons generated on the inspection target by the irradiation with the electron beam, a sensor for detecting the secondary electrons or the reflected electrons via the electrification control electrode, an A/D converter for sequentially converting the signals into digital image signals from an irradiation start point-in-time of the electron beam, the signals being detected by the sensor, an addition circuit for creating a detection image by adding the digital image signals from a first set point-in-time to a second set point-in-time on each pixel basis, and an image processing circuit for judging a defect by comparing the detection image with a reference image of a circuit pattern formed on the inspection target.

According to the present invention, it becomes possible to perform the semiconductor wafer inspection under a suitable condition even if the intensity of secondary electrons or reflected electrons changes in time.

Other objects, features and advantages of the invention will become apparent from the following description of the embodiments of the invention taken in conjunction with the accompanying drawings.

### BRIEF DESCRIPTION OF THE DRAWINGS

FIG. 1A is a plan view of a semiconductor wafer, i.e., an inspection target, and FIG. 1B is a cross-sectional view of the semiconductor wafer, i.e., the inspection target;

FIG. 2 is a diagram for illustrating transient characteristics of secondary electrons or reflected electrons;

FIG. 3 is a configuration diagram of a semiconductor wafer inspection apparatus which is an embodiment of the present invention;

FIG. 4 is a block diagram of the semiconductor wafer inspection apparatus which is the embodiment of the present invention;

FIG. 5 is a flowchart for illustrating recipe creation steps;

FIG. 6 is a timing chart for illustrating deflection amount of an electron beam;

FIG. 7 is an explanatory diagram of GUI for illustrating an inspection-result display screen;

FIG. 8 is an explanatory diagram of the GUI for illustrating a transient-characteristics image display screen;

FIG. 9 is a flowchart for illustrating defect inspection steps;

FIG. 10 is an explanatory diagram of the GUI for illustrating the transient-characteristics display screen of a first modified example of the first embodiment;

FIG. 11 is an explanatory diagram of the GUI for illustrating a test inspection of a second modified example of the first embodiment;

FIG. 12 is a diagram for explaining a beam deflection method of a third modified example of the first embodiment;

FIG. 13 is a configuration diagram of a semiconductor wafer inspection apparatus which is another embodiment of the present invention; and

FIG. 14 is a block diagram of the semiconductor wafer inspection apparatus which is another embodiment of the present invention.

### DESCRIPTION OF THE INVENTION

### 1st Embodiment

(Inspection Target)

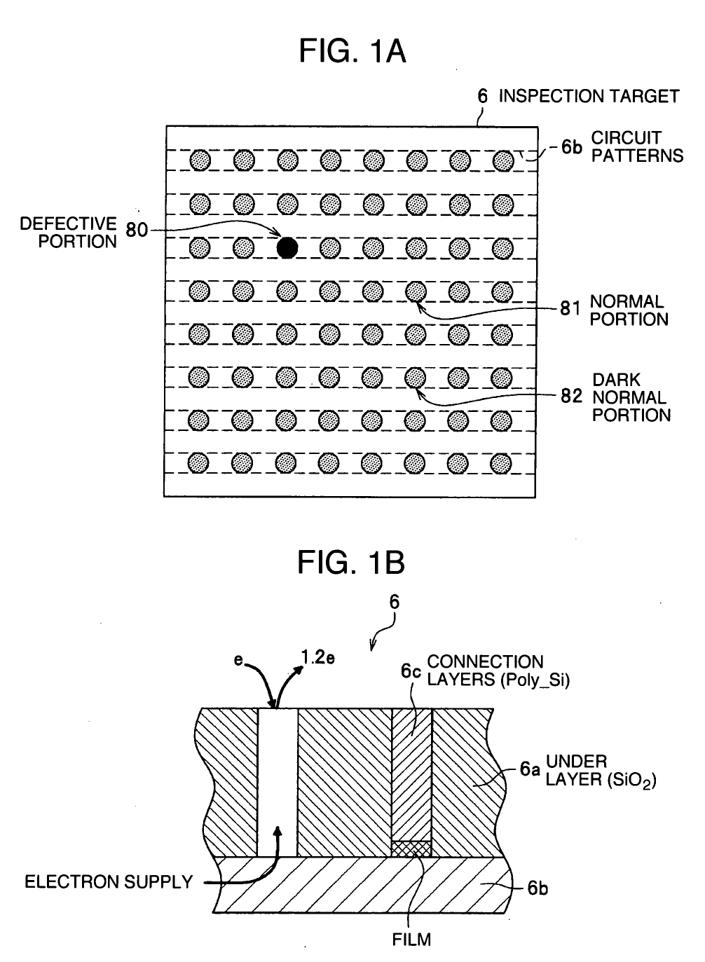

First, referring to FIG. 1A and FIG. 1B, the explanation will be given below concerning an inspection target of a semiconductor wafer inspection apparatus which is an embodiment of the present invention. FIG. 1A is a plan view of a semiconductor wafer, i.e., the inspection target, and FIG. 1B is a cross-sectional view thereof. Incidentally, the semiconductor wafer, which is of about-300-mm-diameter and about-1-mm-thick disc shape, is formed by arranging side by side a few hundreds of about-1-cm-square-size dies. These dies are units each of which is equipped with one and the same circuit pattern, and which finally become commercial products with the same model number by being cut off. Each die includes in its inside a pattern having a constant repetition such as a memory portion, and a circuit with scarce repetition property. Pattern comparison inspection is generally used for the inspection of a circuit pattern like this. In the pattern comparison inspection, the detection image is compared with a reference image created from design information, a reference image of another die detected in advance, or a reference image at a location apart therefrom by the repetition pitch in the repetition portion. Then, a portion at which a difference exists therebetween is judged to be a defect.

In FIG. 1A, the inspection target 6 is the semiconductor wafer in which a plurality of straight-line-shaped circuit patterns 6b are formed on the surface of an under layer. The circuit patterns 6b are connected to another circuit pattern which is formed on a surface opposed to the circuit patterns. Namely, as illustrated in FIG. 1B, in the inspection target 6, e.g., the circuit patterns 6b are formed on the under layer 6a composed of SiO₂. Moreover, a plurality of connection layers 6c, whose cross sections are of circular shape and which are composed of Poly_Si, are formed such that the connection layers 6c pass through the under layer up to the opposed surface.

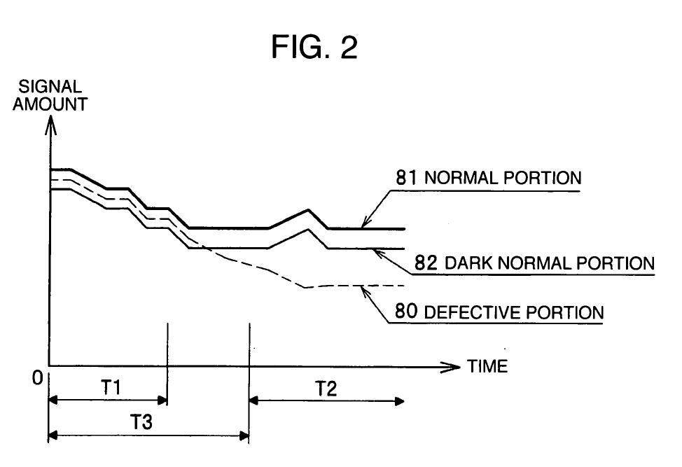

Here, if electrons, each of which has electric charge amount e, enter end surfaces of the connection layers 6c, secondary electrons are generated from the end surfaces, or the electrons are reflected as reflected electrons. The electric charges, however, are gradually accumulated in the connection layers 6c. As a result, intensity (i.e., electric charge amount) of the secondary electrons or reflected electrons gradually decreases as illustrated in FIG. 2. Here, FIG. 2 is a diagram for illustrating the transient characteristics, i.e., relationship between the electric charge amount of the secondary electrons or reflected electrons and time. The longitudinal axis denotes signal amount corresponding to the electric charge amount, and the transverse axis denotes time.

Also, in a normal portion 81 in FIG. 1A, as illustrated in FIG. 1B, the electrons are supplied from the circuit patterns 6b. As a result, in the stationary state, the electric charge amount increases up to, e.g., 1.2 times as much as the electric charge amount of the incident electrons each of which has e. Also, in a defective portion 80 in FIG. 1A, as illustrated in FIG. 1B, a film is formed on the entire plane of an intersection between the circuit patterns 6b and the connection layer 6c. The formation of this film prevents the electrons from the circuit patterns 6b from being supplied to the connection layer 6c. Accordingly, in the defective portion 80, the electric charge amount of the secondary electrons or reflected electrons becomes relatively smaller. Also, in a portion (i.e., dark normal portion 82) in which the insulating film is formed in the defective portion 80 and in part of the intersection between the circuit patterns 6b and the connection layer 6c, the secondary electrons or reflected electrons in an intermediate amount are generated.

As illustrated in FIG. 2, concerning the normal portion 81, the defective portion 80, and the dark normal portion 82, the signal amounts are getting gradually lowered in them all. The respective steady values are getting lowered in the order of the normal portion 81, the dark normal portion 82, and the defective portion 80. The time-interval T1, during which the signal amounts are getting gradually lowered, is a time-interval during which the electric charges are accumulated in the connection layer 6c. Namely, the time-interval T1 is a one during which the surface conditions are identifiable. The time-interval T2, during which the signal amounts differ from each other in the normal portion 81, the dark normal portion 82, and the defective portion 80, is a time-interval during which the defect is identifiable. The semiconductor wafer inspection apparatus, which is the embodiment of the present invention, detects the defect by using the differences in the signal amounts in the time-interval T2. Incidentally, the time-interval raging from the electron-beam irradiation start point-in-time to the start point-in-time of the time-interval T2 is defined as the time-interval T3.

The decrease rate of the signal amount in the defective portion 80 is higher as compared with the one in the normal portion 81. In the initial state, however, what is dominant is the influence of surface secondary-electron generation efficiency. This generation efficiency has nothing to do with the defective portion 80, and thus some of the normal portions 81 are dark. It is possible to distinguish between the defective portion 80 and the normal portions 81 by adding the signals in all the time-intervals on each pixel basis, or by adding on each pixel basis the signals in the time-interval T2 during which the defect is identifiable. Also, there are provided the two time-intervals, i.e., the time-interval T1 during which the surface conditions are identifiable, and the time-interval T2 during which the defective portion 80 is identifiable. It is possible to obtain a higher identification ratio by subtracting an addition result of the signals in the time-interval T1 during which the surface conditions are identifiable from an addition result of the signals in the time-interval T2 during which the defect is identifiable.

(Defect Inspection Apparatus)

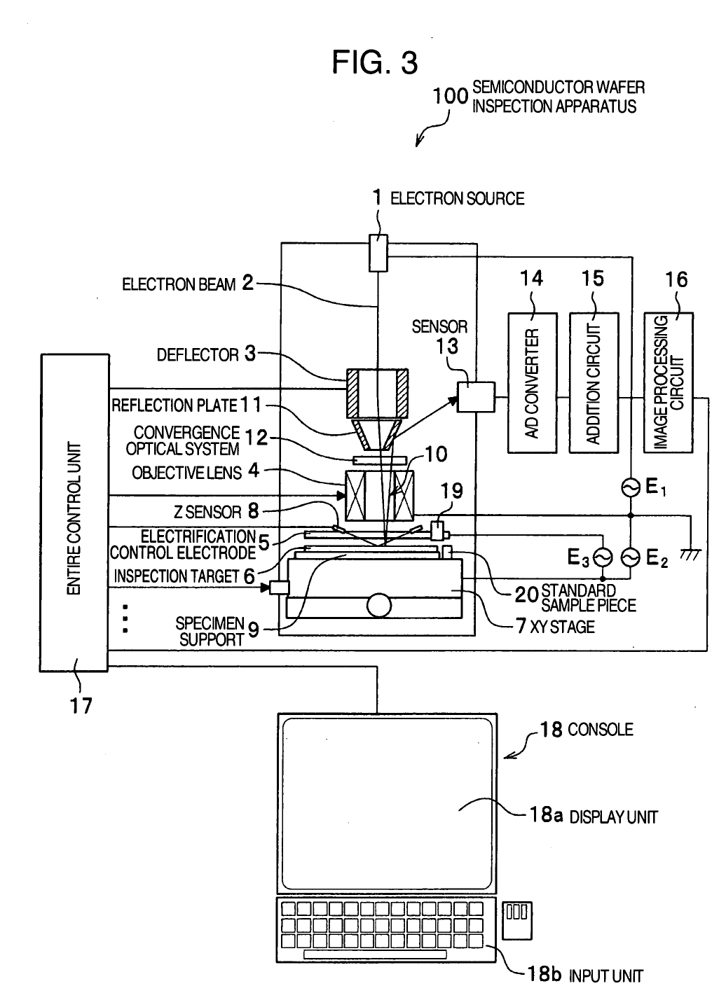

Next, referring to the drawing, the detailed explanation will be given below concerning the semiconductor wafer inspection apparatus which is a defect inspection apparatus. In FIG. 3, the semiconductor wafer inspection apparatus 100 includes an electron source 1 for emitting an electron beam 2, a deflector 3 for deflecting the electron beam 2, an objective lens 4 for focusing the electron beam 2, an electrification control electrode 5 for controlling electric-field intensity so as to control secondary electrons or reflected electrons 10 generated by irradiation with the electron beam 2, an XY stage 7 for moving an inspection target 6 in the X direction and the Y direction, a Z sensor 8 for measuring height of the inspection target 6, a specimen support 9 for holding the inspection target 6, a convergence optical system 12 for converging the secondary electrons or reflected electrons 10 so as to converge the secondary electrons or reflected electrons 10 on a reflection plate 11, the reflection plate 11 for receiving the secondary electrons or reflected electrons 10 so as to generate secondary electrons again, a sensor 13 for detecting the secondary electrons from the reflection plate 11, an A/D converter 14 for converting the analogue signals detected by the sensor 13 into digital image signals, an addition circuit 15 for applying an addition processing to the digital image signals, an image processing circuit 16 for judging a defect by processing an image from the addition circuit 15, an entire control unit 17 for storing judged defect information and controlling the entire apparatus, a console 18 for transferring a user instruction to the entire control unit 17, an optical microscope 19 for photographing an optical image of the inspection target 6, and a standard sample piece 20 set at the same height as the inspection target 6 for adjusting an electron-optics condition.

Also, the objective lens 4 is grounded. An alternating-current power-supply E₁ is connected to the electron source 1, and an alternating-current power-supply E₂ is connected to the XY stage 7. An alternating-current power-supply E₃ is connected between the XY stage 7 and the electrification control electrode 5. Incidentally, the electron source 1 and the objective lens 4 are referred to as “irradiation optical system”, and the deflector 3 and the XY stage 7 are referred to as “scanning unit”. Also, part of control signal lines from the entire control unit 17 is described, but the other control signal lines are omitted since the drawing becomes complicated. Also, since the drawing becomes complicated, the signal line and explanation are omitted here regarding an ExB for deflecting the secondary electrons or reflected electrons 10 by changing orbits of the secondary electrons or reflected electrons 10 generated by the electron beam 2 and the inspection target 6, a wafer cassette for storing the inspection target 6, and a loader for loading/unloading wafers in the cassette.

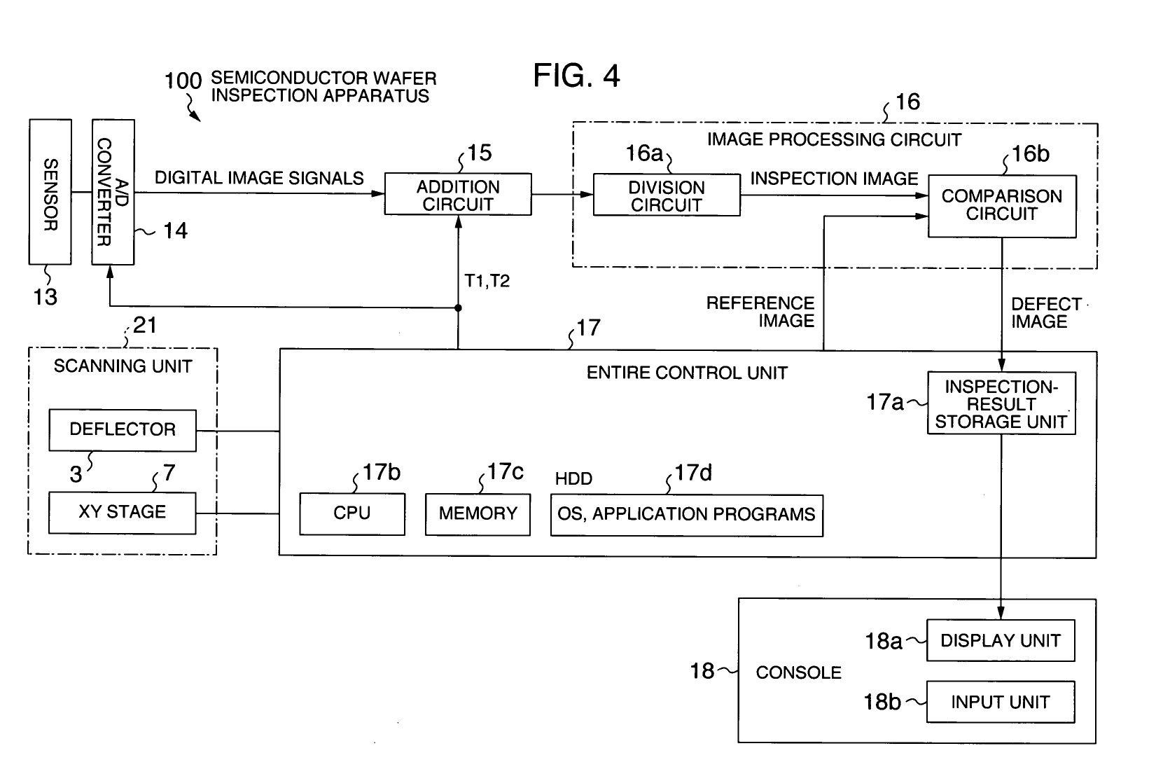

Next, referring a block diagram in FIG. 4, the explanation will be given below concerning flow of the signals.

The entire control unit 17 scans the electron beam 2 by controlling the scanning unit 21 which includes the deflector 3 and the XY stage 7. While performing this scanning, the entire control unit 17 orders the A/D converter 14 to convert the analogue signals outputted by the sensor 13 into the digital image signals. At this time, the entire control unit 17 causes the addition circuit 15 to add the plurality of digital image signals on each pixel basis during the time-interval T2, which is after the lapse of the predetermined time-interval T3 (refer to FIG. 2) from the irradiation start point-in-time of the electron beam 2. Namely, the entire control unit 17 reads and discards the outputted image signals from the A/D converter 14 during the time-interval T3, and adds the outputted image signals during the time-interval T2. Moreover, the resultant addition image is inputted into the image processing circuit 16. Then, a division circuit 16a divides the addition image by a value corresponding to the time-interval T2, thereby creating a detection image. Furthermore, a comparison circuit 16b extracts a defect image by comparing the detection image with a reference image created in advance.

This defect image is stored into an inspection-result storage unit 17a of the entire control unit 17, and is displayed on a display unit 18a of the console 18. Also, the entire control unit 17 controls the scanning unit 21, the A/D converter 14, the addition circuit 15, the image processing circuit 16, and the console 18. The entire control unit 17 includes a CPU 17b, a memory 17c, and a HDD (Hard Disc Drive) 17d. The HDD 17d stores therein an OS and application programs, which are expanded onto the memory 17c so as to be executed. Additionally, the display unit 18a is so configured as to display the inspection image and the reference image as well when required.

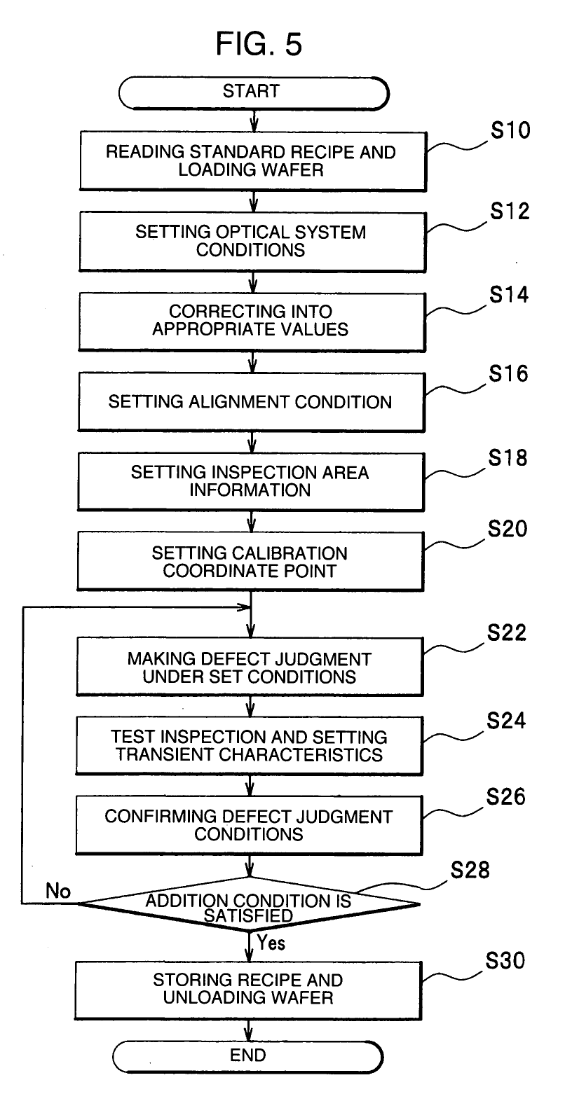

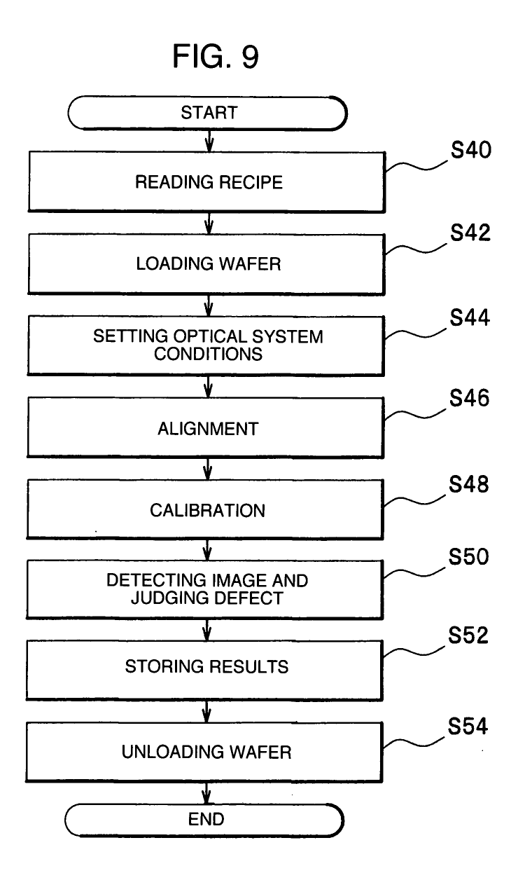

When performing the defect inspection, recipe creation is performed following recipe creation steps illustrated in advance in FIG. 5. Next, in accordance with this recipe, the defect inspection is performed following steps illustrated in FIG. 9. First of all, referring to FIG. 5, the explanation will be given below concerning the recipe creation steps. Operator requests the instruction to the entire control unit 17, using the console 18. In accordance with this instruction, the entire control unit 17 reads a standard recipe (S10). Moreover, the unit 17 wafer-loads the wafer cassette (not illustrated) using the loader (not illustrated) (S10), then mounting the wafer cassette on the specimen support 9.

The entire control unit 17 sets respective types of optical system conditions with the electron source 1, the deflector 3, the objective lens 4, the electrification control electrode 5, the reflection plate 11, the convergence optical system 12, the sensor 13, and the A/D converter 14 (S12). Next, the image processing circuit 16 detects an image of the standard sample piece 20, thereby correcting the conditions into appropriate values (S14). Next, the entire control unit 17 sets pattern layout of the inspection target 6, and registers part of the patterns and their coordinates, then setting an alignment condition (S16). Next, the entire control unit 17 sets inspection area information including a memory cell area and a die area (S18). The entire control unit 17 selects a coordinate point at which an image suitable for calibration is to be acquired, then setting an initial gain and the calibration coordinate point (S20).

Next, the entire control unit 17 makes the defect judgment under the set conditions (S22). Namely, the operator selects and specifies the inspection area, pixel size, and addition number-of-times using the console 18 (FIG. 3). The entire control unit 17 sets these defect judgment conditions. Based on the set conditions, the entire control unit 17 moves the XY stage 7, and scans the deflector 3 in synchronization with the displacement. In this way, using the sensor 13, the entire control unit 17 detects the secondary electrons or reflected electrons 10 generated by the electron beam 2 with which the surface of the inspection target 6 is irradiated via the objective lens 4. At this time, based on the height of the inspection target 6 detected by the Z sensor 8, the entire control unit 17 controls magnetizing current value of the objective lens 4, thereby correcting the focal-point position. Using the A/D converter 14, the entire control unit 17 converts the analogue signals detected by the sensor 13 into the digital image signals.

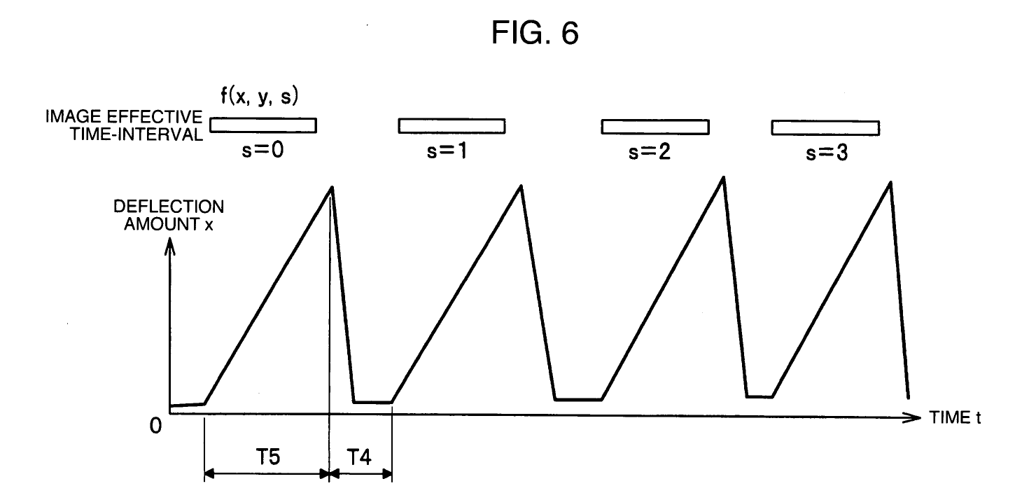

When the addition circuit 15 performs the addition of the digital image signals, if a single-line scanning area is taken into consideration, the detection and addition process is represented by a timing chart in FIG. 6. In this timing chart, the longitudinal axis denotes deflection amount x, and the transverse axis denotes time. The deflection amount x given by the deflector 3 includes a pixel effective time-interval T5 during which the deflection amount x is swept in a triangular-wave-like configuration thereby to detect a digital image f (x, y, s), and a retrace line time-interval T4. The time-interval T5 and the time-interval T4 are repeated as s=0, 1, 2, . . . . When the addition circuit 15 adds the digital images thus detected, the addition circuit 15 calculates F (x, y). Here, F (x, y) is calculated by addition-averaging the detected digital images f (x, y, s) using the following Expression (1), letting the addition number-of-times at the same location be sm. Incidentally, (sb−sa+1) is a value corresponding to the time-interval T2 (FIG. 2).
[Expression 1]

$$F ( x , y ) = \frac{{\sum }_{s = sa}^{sb} f ( x , y , s )}{( sb - sa + 1 )} \qquad Expression ( 1 )$$

Using the addition-averaged image F (x, y), the image F (x, y) is compared with an image at a location (position) at which the same pattern should be provided. Then, an area in which a difference exists between the images is judged to be a defect (S22 in FIG. 5).

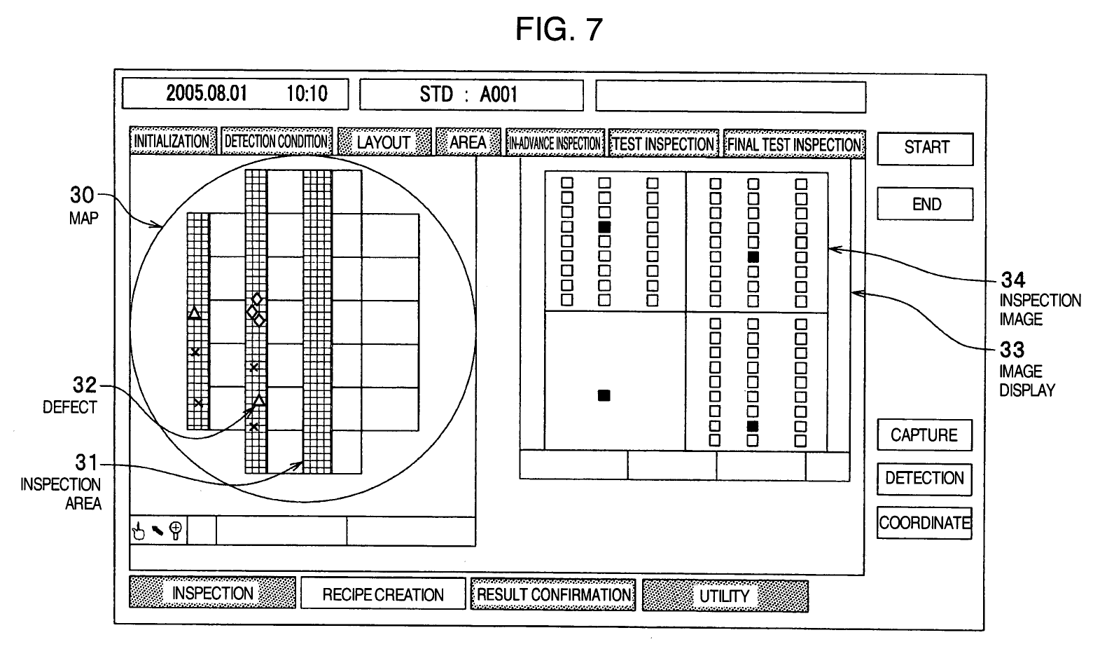

The coordinate judged to be the defect is map-displayed on the console 18. FIG. 7 illustrates an example of the map display. FIG. 7 illustrates GUI (:Graphical User Interface) for the recipe creation displayed on the screen of the console 18. The inspection area 31 and the defect 32 are displayed on a map 30. Selecting the defect 32 using a method such as mouse click causes an image display 33 to display an inspection image 34 in proximity to the defect acquired at the time of the inspection.

Getting back to FIG. 5, the operator selects a defect point which is suitable for the condition setting, then performing a test-inspection operation (S24). In the test-inspection operation, the addition circuit 15 is set at “through”, and the other components are set similarly to ordinary inspections. Namely, based on the set conditions, the entire control unit 17 displaces the XY stage 7, and scans the deflector 3 in synchronization with the displacement. In this way, using the sensor 13, the entire control unit 17 detects the secondary electrons or reflected electrons 10 generated by the electron beam 2 with which the surface of the inspection target 6 is irradiated via the objective lens 4. At this time, based on the height of the inspection target 6 detected by the Z sensor 8, the entire control unit 17 controls the magnetizing current value of the objective lens 4, thereby correcting the focal-point position. Also, using the A/D converter 14, the entire control unit 17 converts the analogue signals outputted by the sensor 13 into the digital image signals. The image processing circuit 16 directly stores the digital image signals f (x, y, s) into a memory inside the circuit 16 thorough the addition circuit 15. After the storage operation by the memory has been finished, the addition operation based on the Expression (1) is performed by an operation inside the image processing circuit 16. Then, the defect judgment operation is performed, thereby confirming that the defect on which the attention is focused can be judged. Next, a detection image to which no addition operation is applied and whose detection number-of-times is equal to s is defined by the following Expression (2).

[Expression 2]
Fs(x,y)=f(x,y,s) Expression (2)

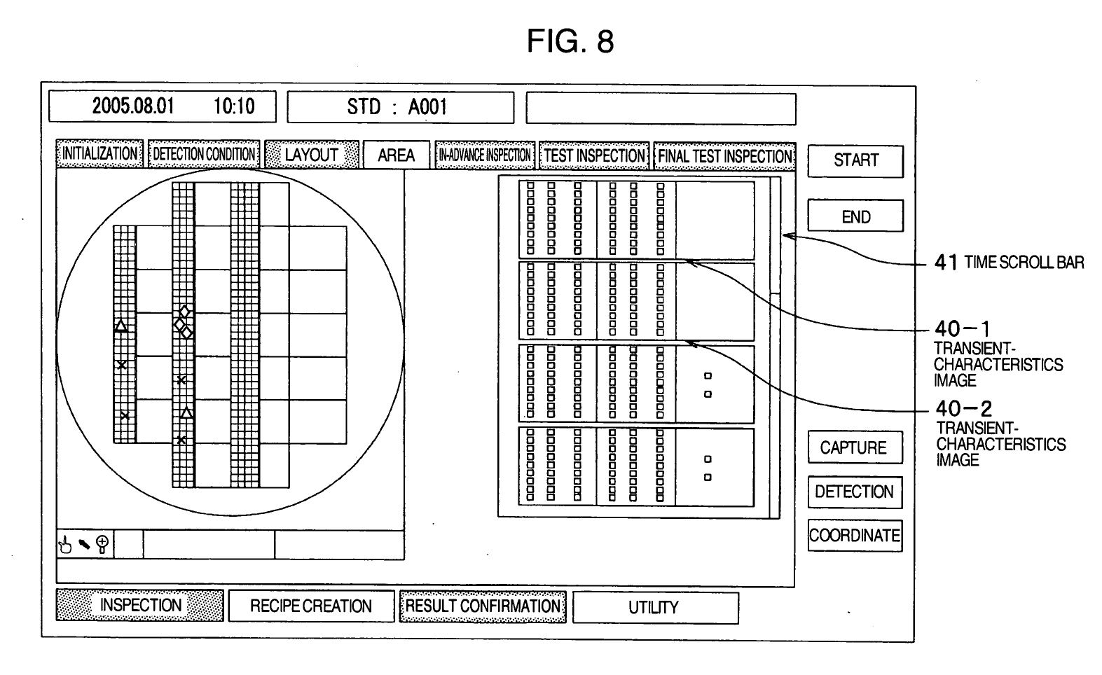

FIG. 8 exemplifies transient-characteristics images displayed on the console 18. FIG. 8 illustrates detection images on each s basis and the differential images therebetween. The transient-characteristics images 40-1 and 40-2 indicate that the images 40-1 and 40-2 are images whose detection number-of-times are equal to s=1, 2. Operating a time scroll bar 41 makes it possible to select a transient-characteristics image to be displayed. From these transient-characteristics images, the operator can judge the following situations by visual check: Namely, S/N ratio merely lacks, and equivalent images have been able to be detected, but the defect judgment cannot be made unless the S/N ratio is made higher by the addition operation. Otherwise, a defect cannot be made conspicuous until a certain constant time has elapsed. Otherwise, the defect can be made conspicuous only during a certain constant time-zone, and the identification is difficult during the other time-zones. In this way, the transient-characteristics images which can make the defect identifiable are identified. Only after confirming that the stability is ensured regarding a plurality of defects, the operator sets the addition circuit 15 so that the addition circuit 15 will select and add only the identified transient-characteristics images, thus performing the transient-characteristics setting (S24). The setting of the addition condition is given by the following Expression (3): The addition circuit 15 does not add the images for all s, but adds only the images with the constant image acquisition detection number-of-times from sa to sb corresponding to the time-interval T2.
[Expression 3]

$$F ( x , y ) = {\sum }_{s = sa}^{sb} f ( x , y , s ) \qquad Expression ( 3 )$$

The setting of the additional circuit 15 is given by following Expression (4); where the additional weight from s=sa to s=sb is not uniform, but pre-set coefficient C(s) is applied.
[Expression 4]

$$F ( x , y ) = {\sum }_{s = sa}^{sb} C ( s ) \times f ( x , y , s ) \qquad Expression ( 4 )$$

Next, the entire control unit 17 makes the defect judgment again under the newly set addition condition to confirm the defect judgment conditions (S26), thereby judging whether or not the addition condition for the addition circuit 15 is satisfied (S28). If the addition condition is satisfied (i.e., Yes at S28), the entire control unit 17 stores the recipe including the addition condition into the memory, then terminating the recipe creation, and unloading the wafer (S30). Meanwhile, if the addition condition is not satisfied (i.e., No at S28), the entire control unit 17 gets back to S22.

Next, referring to the flowchart in FIG. 9, the explanation will be given below concerning the defect inspection steps. The operator transfers the instruction to the entire control unit 17, using the console 18. Based on this instruction, the entire control unit 17 reads a recipe suitable for the inspection target 6 (S40). Moreover, the unit 17 wafer-loads a wafer cassette (not illustrated) using the loader (not illustrated) (S42), then mounting this wafer cassette on the specimen support 9. The entire control unit 17 sets the optical system conditions with the electron source 1, the deflector 3, the objective lens 4, the electrification control electrode 5, the reflection plate 11, the convergence optical system 12, and the sensor 13 (S44), then setting the optical system condition for the A/D converter 14 as well. Moreover, the entire control unit 17 detects an image of the standard sample piece 20, thereby correcting the conditions into appropriate values. The entire control unit 17 performs the alignment under the set conditions (S46), and acquires an image for the calibration (S48). The entire control unit 17 sets the image acquisition condition on the gain of the sensor 13 and the like so that the light amount becomes an appropriate light amount which does not cause light-amount shortage or light-amount excess to occur.

Next, the entire control unit 17 makes the image detection and defect judgment on an inspection area set in advance (S50). In this image detection and defect judgment, based on the set conditions, the entire control unit 17 displaces the XY stage 7, and scans the deflector 3 in synchronization with the displacement. In this way, using the sensor 13, the entire control unit 17 detects the secondary electrons or reflected electrons 10 generated by the electron beam 2 with which the surface of the inspection target 6 is irradiated via the objective lens 4. At this time, based on the height of the inspection target 6 detected by the Z sensor 8, the entire control unit 17 controls the magnetizing current value of the objective lens 4, thereby correcting the focal-point position. Also, using the A/D converter 14, the entire control unit 17 converts the analogue signals outputted by the sensor 13 into the digital image signals. The addition circuit 15 performs the addition in accordance with the addition condition, thereby acquiring the addition image given by the Expression (3). The unit 17 makes the defect judgment based on the acquired addition image. The unit 17 stores results including the defect judgment result and the inspection conditions (S52). Furthermore, the unit 17 unloads the inspection target 6 (S54), thereby terminating the defect inspection.

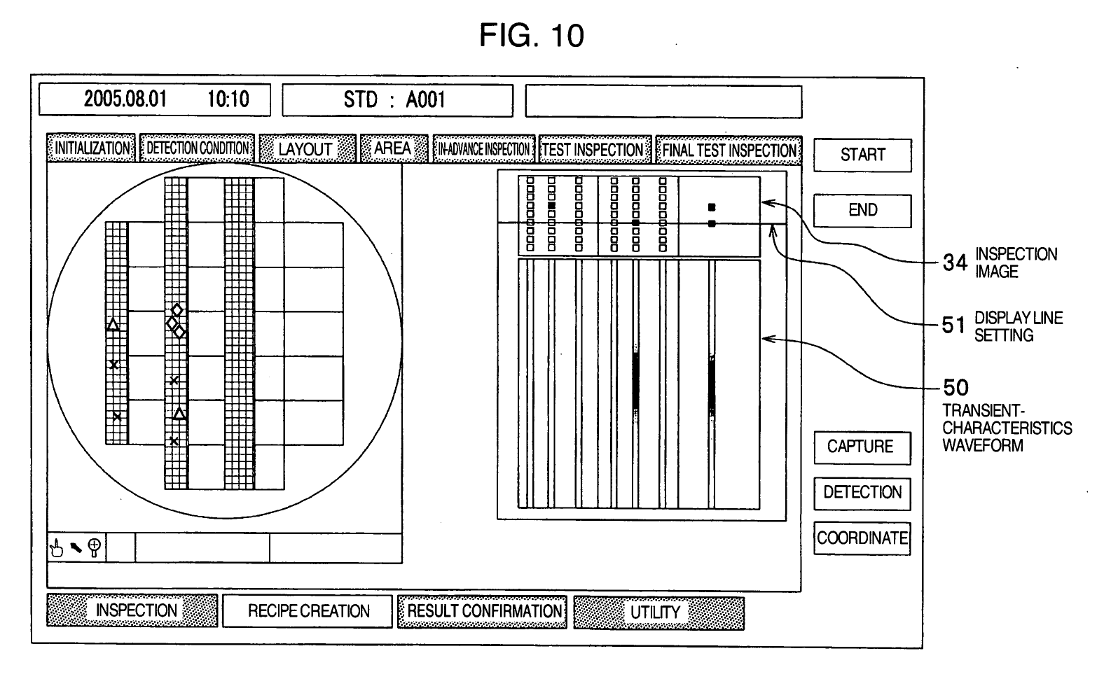

Next, the explanation will be given below concerning a first modified example of the present embodiment. FIG. 10 illustrates the transient-characteristics display screen of the first modified example. This screen includes the inspection image 34 of a selected defect, a display line setting 51 for setting the transient-characteristics waveform 50, and the transient-characteristics waveform 50 about which the longitudinal axis denotes time and the transverse axis denotes the location. According to the present modified example, it becomes possible to intuitively grasp a time change in differential image or original image. This allows the time-interval appropriate for the addition to be set more easily.

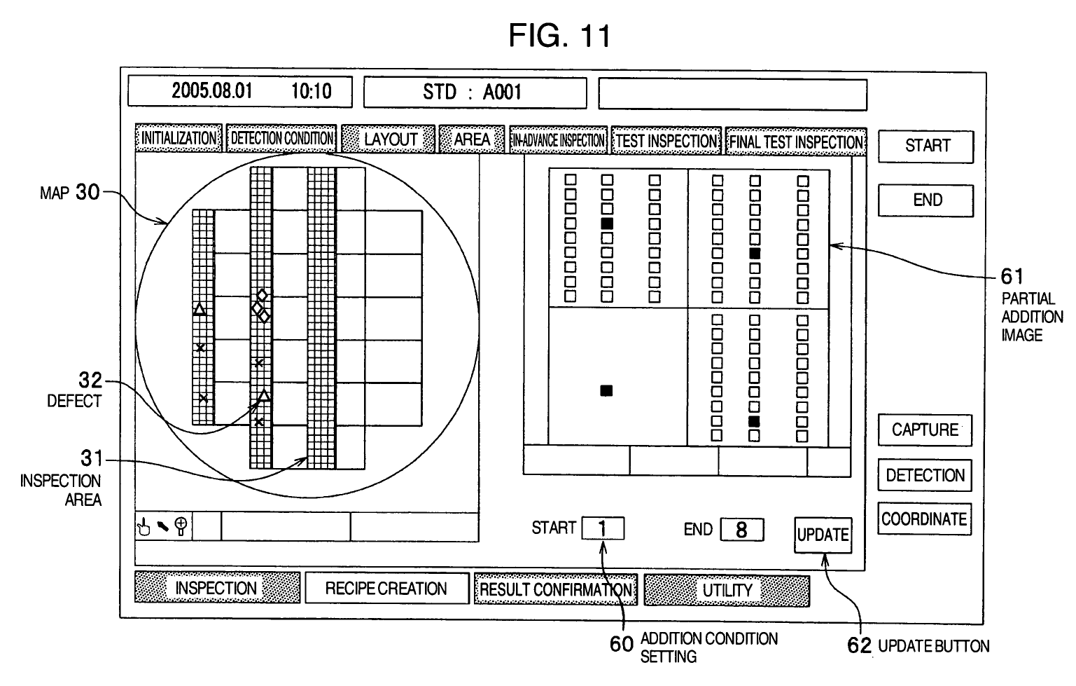

Next, the explanation will be given below concerning a second modified example of the present embodiment. FIG. 11 illustrates the GUI screen of the second modified example. This screen includes an addition condition setting 60, display of a partial addition image 61 acquired by performing the addition partially in accordance with the addition condition, and an update button 62 for updating a defect displayed on the map 30. Next, the explanation will be given below regarding operation of this modified example. Changing a start timing and an end timing of the addition condition setting 60 makes it possible to set an addition range. The partial addition image 61 displayed when a defect is selected becomes an image acquired by performing the addition from the start timing to the end timing. Also, clicking on the update button 62 allows the defect judgment to be made based on the image data stored in the image processing circuit 16, thereby making it possible to update the defect 32 displayed on the map 30. According to the present modified example, it becomes possible to judge, in a short time-interval, the image displayed when the addition condition is changed, and to make the defect judgment once again. This allows the time-interval appropriate for the addition to be set and confirmed more easily.

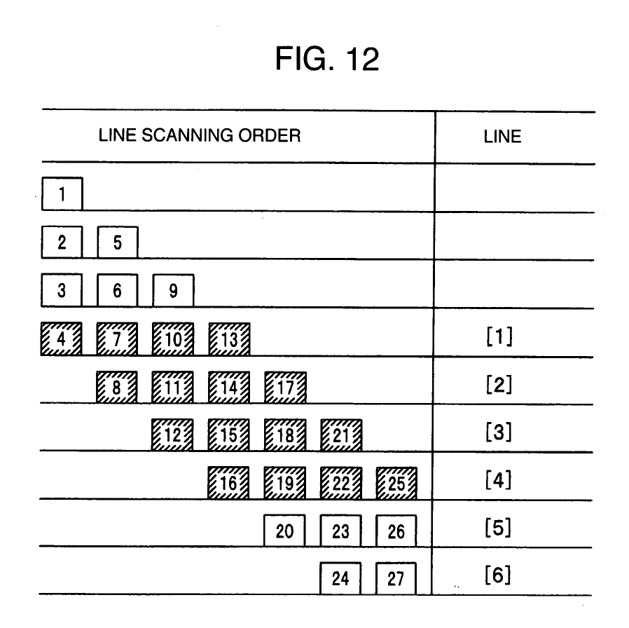

Next, the explanation will be given below concerning a third modified example of the present embodiment. In the present embodiment, the explanation has been given regarding the following scheme: One and the same line is scanned a plurality of times, and the scanning is displaced to the next line, and one and the same line is scanned a plurality of times again. The lines, however, need not be scanned in the sequential manner. Instead, the beam deflection method for an electron beam can be modified into the scheme illustrated in FIG. 12. Namely, in the present modified example, the line scanning is performed in the numeric order indicated by the line scanning order. As a result, it turns out that one and the same line is scanned over four times. In this case as well, the argument on the addition remains the same. For example, the scanning for the line [1] becomes the scannings of scanning orders of 4, 7, 10, and 13. If the orders of these scannings are defined as being 1, 2, 3, and 4, the same argument as the one described earlier holds. In the scheme illustrated in FIG. 12, it turns out that the transient characteristics are obtained whose time-interval is four times longer as compared with the time-interval of the scheme where one and the same line is scanned a plurality of times.

According to the present modified example, it becomes possible to control the addition with respect to the different scanning scheme as well. This allows implementation of a feature of being capable of addressing the transient characteristics with various types of time constants.

According to the present embodiment, it becomes possible for the operator to set the addition circuit 15 so that the addition circuit 15 will select and add only the transient-characteristics images which makes it possible to make a defect identifiable. Based on this setting, the semiconductor wafer inspection apparatus 100 is capable of detecting the defect of the inspection target 6. For example, the semiconductor wafer inspection apparatus 100 is capable of detecting the defect to which the supply amount of the electrons is reduced during the time-interval T2 (FIG. 2) by the fact that the film is formed between the circuit patterns 6b and the connection layer 6c. Also, based on the GUI function for displaying the graph illustrated in FIG. 11 and the graph displayed, the calculation function is set for the transient characteristics. Then, the defect judgment is made based on this setting. Accordingly, it becomes possible to provide the inspection apparatus and its inspection method which allows implementation of the inspection under the inspection conditions suitable for each type of processing step and defect type. Also, it is satisfying enough for the image processing circuit 16 of the present embodiment to have the capability for making it possible to process the addition image in real time. Namely, a small-scaled image processing circuit is useful enough to address this need. Also, the addition condition is applied to an actual defect, and its result can be visualized. This allows implementation of a feature of being capable of setting the suitable conditions.

### 2nd Embodiment

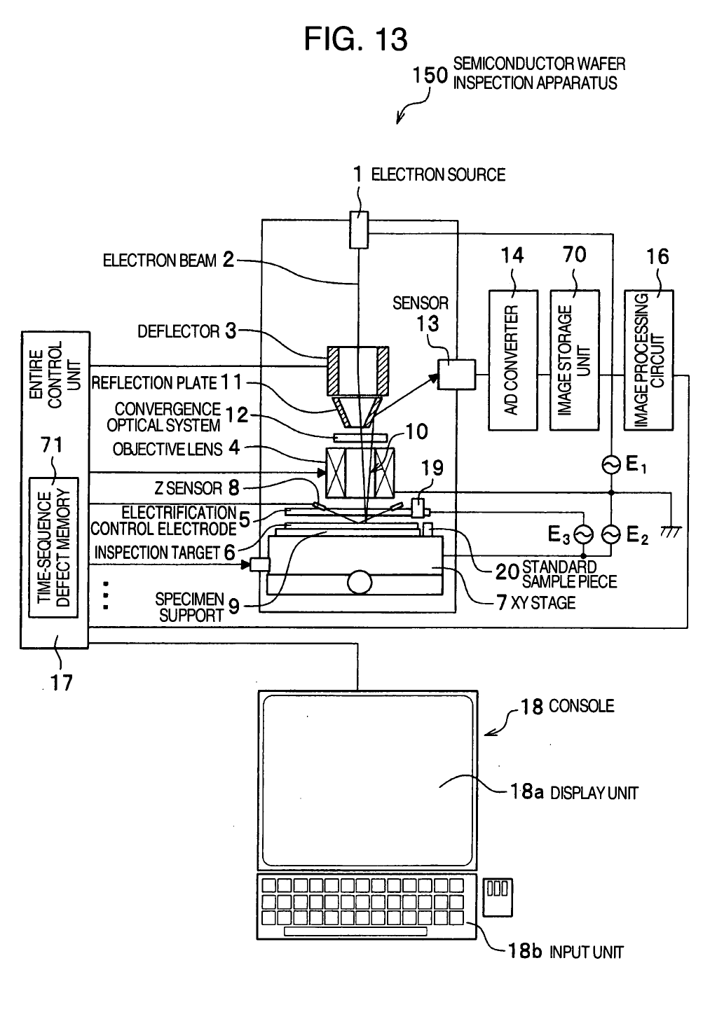

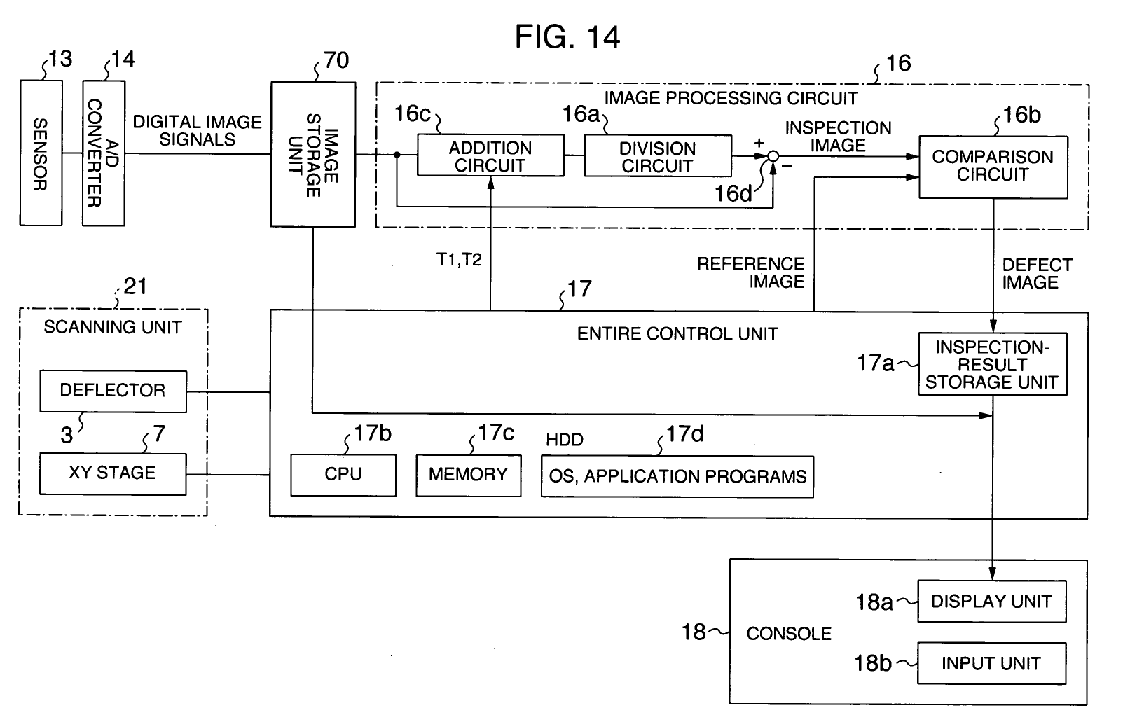

A semiconductor wafer inspection apparatus which is a second embodiment of the present invention includes basically the same configuration as that of the semiconductor wafer inspection apparatus 100 illustrated in the first embodiment. The semiconductor wafer inspection apparatus 150 illustrated in FIG. 13, however, differs from the semiconductor wafer inspection apparatus 100 illustrated in the first embodiment in a point that it includes an image storage unit 70 and a time-sequence defect memory 71. Here, the image storage unit 70 is provided between the A/D converter 14 and the image processing circuit 16, and the time-sequence defect memory 71 stores time-sequence defect information in proximity to a point judged to be a defect. Also, a block diagram illustrated in FIG. 14 also differs from FIG. 4 in the point that it includes the image storage unit 70, and the division circuit 16a, an addition circuit 16c, and a subtractor 16d, which are provided inside the image processing circuit 16. The subtractor 16d performs a subtraction between an output signal from the division circuit 16a and an image signal stored in the image storage unit 70.

When performing the defect inspection, as is the case with the first embodiment, the recipe creation is performed in accordance with the flowchart illustrated in advance in FIG. 5. Next, the defect inspection is performed in accordance with the flowchart illustrated in FIG. 9. In FIG. 5, “reading standard recipe and loading wafer” (S10), “setting optical system conditions” (S12), “correcting into appropriate values” (S14), “setting alignment condition” (S16), “setting inspection area information” (S18), and “setting calibration coordinate point” (S20) are the same as those of the first embodiment.

Next, the defect judgment is made under the set conditions (S22). This step differs from that of the first embodiment in the following points: Namely, using the deflector 3, the deflection amount x is swept in a triangular-wave-like configuration thereby to detect a digital image f (x, y, s) at that time. Then, the detected digital images f (x, y, s) are stored into the image storage unit 70, letting the addition number-of-times at the same location be sm. Also, using the digital images f (x, y, s) detected in the time sequence, the images f (x, y, s) are compared with images at locations at which the same patterns should be provided. Then, areas in which differences exist between the images are judged to be defects. In the initial condition, the defect judgment is performed using an image acquired by performing the addition processing based on the Expression (1) inside the image processing circuit. Then, the images detected in the time sequence in proximity to the defects are stored into the time-sequence defect memory 71. Simultaneously, the coordinates judged to be the defects, and the inspection image 34 resulting from addition-averaging the detect images using the Expression (1) are map-displayed on the console 18. Here, the detect images are acquired at the time of the inspection on the image display 33 (FIG. 7), and are stored into the time-sequence defect memory 71.

Next, the operator selects a defect point which is suitable for the condition setting, then performing the test-inspection operation (S24). Here also, the second embodiment differs from the first embodiment in a point that the entire control unit 17 stores the digital signals f (x, y, s) into the image storage unit 70. Furthermore, “confirming defect judgment conditions” (S26), “addition condition is satisfied” (S28), and “storing recipe and unloading wafer” (S30) are executed, then terminating the processing.

Next, the explanation will be given below concerning a first modified example of the present embodiment. After identifying the defects which become the targets at the time of setting the recipe, the test inspection is performed. The transient characteristics of the defective portions, however, have been already stored into the time-sequence defect memory 71. Although the update button 62 illustrated in FIG. 11 is not used, the other functions are applicable without performing the inspection again. These functions are integrated into the GUI. According to the present modified example, it becomes possible to set the addition condition without repeating the inspection.

Next, the explanation will be given below concerning a second modified example of the present embodiment. In the test inspection, the transient response data other than the defective portions are stored in the storage mechanism. Although the displays illustrated in FIG. 8, FIG. 10, and FIG. 11 are about the defective portions, basically the same displays are implementable for portions other than the defective portions. These other functions are integrated into the GUI. According to the present modified example, it becomes possible to grasp the transient characteristics of the portions other than the defective portions. This allows the addition condition to be set more accurately by using the comparison with the defective portions.

Next, the explanation will be given below concerning a third modified example of the present embodiment. As was explained earlier using FIG. 2, it is possible to subtract an addition result of the signals in the time-interval T1 during which the surface conditions are identifiable from an addition result of the signals in the time-interval T2 during which the defect is identifiable. In other words, it is possible to obtain a higher identification ratio in the following way: An image group acquired by scanning one and the same location a plurality of times is divided for each of a plurality of time-intervals. Next, signals of the divided image groups within the time-intervals are added for each pixel. Finally, the subtraction is performed between the added images for each pixel.

It should be further understood by those skilled in the art that although the foregoing description has been made on embodiments of the invention, the invention is not limited thereto and various changes and modifications may be made without departing from the spirit of the invention and the scope of the appended claims.

1. An inspection apparatus for inspecting a semiconductor wafer, comprising:
an irradiation optical system for irradiating an inspection target with an electron beam;
a scanning unit for scanning an irradiation position of said electron beam of said irradiation optical system in the X direction and the Y direction;
an electrification control electrode for controlling secondary electrons or reflected electrons generated on said inspection target by said irradiation with said electron beam;
a sensor for detecting said secondary electrons or said reflected electrons via said electrification control electrode;
an A/D converter for sequentially converting said signals into digital image signals from an irradiation start point-in-time of said electron beam, said signals being detected by said sensor;
an addition circuit for creating a detection image by adding said digital image signals from a first set point-in-time to a second set point-in-time on each pixel basis; and
an image processing circuit for judging a defect by comparing said detection image with a reference image of a circuit pattern formed on said inspection target.

2. The inspection apparatus according to claim 1, wherein
said inspection target includes a connection layer which passes through an under layer on which said circuit pattern is formed,
said defect being a defect which is produced by adherence of a film between said connection layer and said circuit pattern.

3. An inspection apparatus for inspecting a semiconductor wafer, comprising:
an irradiation optical system for irradiating an inspection target with an electron beam;
a scanning unit for scanning an irradiation position of said electron beam of said irradiation optical system in the X direction and the Y direction, and scanning one and the same location of said inspection target a plurality of times;
an electrification control electrode for controlling secondary electrons or reflected electrons generated on said inspection target by said irradiation with said electron beam;
a sensor for detecting said secondary electrons or said reflected electrons via said electrification control electrode;
an A/D converter for sequentially converting said signals into digital image signals from an irradiation start point-in-time of said electron beam, said signals being detected by said sensor;
an image storage memory for storing said digital image signals; and
an image processing circuit for reading said digital image signals from said image storage memory, and judging a defect by comparing a detection image with a reference image of a circuit pattern formed on said inspection target, said detection image being acquired by applying a calculation processing to all or part of an image group, said image group being acquired by scanning said one and the same location a plurality of times.

4. The inspection apparatus according to claim 3, further comprising:
an inspection-result storage unit for storing information on said judged defect.

5. The inspection apparatus according to claim 4, wherein said inspection-result storage unit stores an image group in an area in proximity to said defect.

6. The inspection apparatus according to claim 3, wherein said calculation processing is an addition processing.

7. The inspection apparatus according to claim 3, wherein
said calculation processing divides said image group for each of a plurality of time-intervals, adds said signals of said divided image groups within said time-intervals for each pixel, and performs a subtraction between said added images for each pixel.

8. The inspection apparatus according to claim 4, further comprising:
a display for displaying said digital image signals in a two-dimensional manner of detection number-of-times and location, said digital image signals being stored into said image storage memory or said inspection-result storage unit.

9. The inspection apparatus according to claim 3, further comprising:
a display for displaying images by adding said images, said images being acquired in a specific scanning number-of-times out of said digital image signals stored into said image storage memory or said inspection-result storage unit.

10. The inspection apparatus according to claim 3, wherein
said inspection target includes a connection layer which passes through an under layer on which said circuit pattern is formed,
said defect being a defect which is produced by adherence of a film between said connection layer and said circuit pattern.

11. An inspection method for inspecting a semiconductor wafer, comprising the steps of:
irradiating an inspection target with an electron beam;
scanning an irradiation position of said electron beam in the X direction and the Y direction, and scanning one and the same location of said inspection target a plurality of times;
controlling secondary electrons or reflected electrons by an electrification control electrode, said secondary electrons or said reflected electrons being generated on said inspection target;
detecting said secondary electrons or said reflected electrons via said electrification control electrode;
sequentially converting said detected signals into digital image signals; and
judging a defect by comparing a detection image with a reference image of a circuit pattern formed on said inspection target, based on said scanning at said scanning step, said detection image being acquired by applying a calculation processing to all or part of an image group, said image group being acquired by dividing said digital image signals in time.

12. The inspection method according to claim 11, further comprising a step of:
determining an operation condition based on an inspection-condition recipe, said operation condition being any one of or a combination of condition on an electron-optics system of said electron beam, voltage of said electrification control electrode, pixel size of each of said images, irradiation current amount of said electron beam, conversion rate of said digital conversion, and image acquisition number-of-times of said one and the same location.

13. The inspection method according to claim 11, further comprising the steps of:
irradiating said inspection target with said electron beam while scanning said electron beam in at least one scanning direction; and
displacing said inspection target in a direction which is different from said scanning direction.

14. The inspection method according to claim 11, wherein
execution of said calculation processing performs an addition processing, or divides said signals into a plurality of groups to perform an addition processing of pixels within said respective groups, and performs a subtraction processing of said pixels between said respective groups.
